(19) United States
(12) Patent Application Publication
(10) Pub. No.: US 2025/0368789 A1
(43) Pub. Date: Dec. 4, 2025

(54) ARTICLES COMPRISING POLYVINYL BUTYRAL AND POLYOLEFIN ELASTOMER

(71) Applicant: Avient Corporation, Avon Lake, OH (US)

(72) Inventors: Shu LIU, Lake in the Hills, IL (US); Liang XU, Vernon Hills, IL (US)

(73) Assignee: Avient Corporation, Avon Lake, OH (US)

(21) Appl. No.: 18/707,876

(22) PCT Filed: Nov. 9, 2022
(86) PCT No.: PCT/US2022/049417

§ 371 Date: May 6, 2024

Related U.S. Application Data
(60) Provisional application No. 63/277,943, filed on Nov. 10, 2021.

(51) Int. Cl. C08J 3/24; C08F 255/02; C08F 287/00; C08J 3/20; C08K 5/00; C08K 5/14; C08K 5/5425

(52) U.S. Cl. CPC C08J 3/246; C08J 3/203; C08K 5/14; C08F 255/023; C08F 287/00; C08J 2353/00; C08J 2451/06; C08K 5/0016; C08K 5/5425

(57) ABSTRACT

Embodiments of the present disclosure are directed to articles comprising a crosslinked reaction product of polyvinyl butyral (PVB), polyolefin elastomer (POE), and silane crosslinker. The PVB comprises virgin PVB, recycled PVB, bio-based PVB, or a combination thereof. The POE comprises olefin block copolymer (OBC), ethylene alpha-olefin copolymer, or a combination thereof. The POE is silane grafted. The grafted silane enables intramolecular silane crosslinking of the POE, intermolecular silane crosslinking of the PVB and POE, or both.

### CLAIM OF PRIORITY

This application claims the benefit of U.S. Provisional Patent Application Ser. No. 63/277,943 bearing Attorney Docket Number 1202107 and filed on Nov. 10, 2021, which is hereby incorporated by reference in its entirety.

### TECHNICAL FIELD

Embodiments of the present disclosure are generally related to articles, and are specifically related to articles of polyvinyl butyral and polyolefin elastomer having improved compression set at higher temperatures.

### BACKGROUND

Polyvinyl butyral (PVB) is widely used in coatings and adhesives in automotive and construction applications because it provides the toughness and flexibility (e.g., hardness) as well as binding capabilities demanded by these applications. However, the properties of PVB start to degrade at higher temperatures (e.g., greater than or equal to 70° C.) and may not be suitable for certain high temperature applications.

Accordingly, a continual need exists for articles that have improved performance at high temperatures while providing the hardness desired when using PVB.

### SUMMARY

Embodiments of the present disclosure are directed to articles comprising a crosslinked reaction product of polyvinyl butyral (PVB), polyolefin elastomer (POE), and silane crosslinker, which provide improved compression set at higher temperatures and exhibit sufficient hardness.

According to one embodiment, an article is provided. The article comprises a crosslinked reaction product of polyvinyl butyral (PVB), polyolefin elastomer (POE), and silane crosslinker. The PVB comprises virgin PVB, recycled PVB, bio-based PVB, or a combination thereof. The POE comprise olefin block copolymer (OBC), ethylene alpha-olefin copolymer, or a combination thereof. The POE is silane grafted. The grafted silane enables intramolecular silane crosslinking of the POE, intermolecular silane crosslinking of the PVB and POE, or both.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of articles, specifically articles comprising a crosslinked reaction product of polyvinyl butyral (PVB), polyolefin elastomer (POE), and silane crosslinker. The PVB comprises virgin PVB, recycled PVB, bio-based PVB, or a combination thereof. The POE comprises olefin block copolymer (OBC), ethylene alpha-olefin copolymer, or a combination thereof. The POE is silane grafted. The grafted silane enables intramolecular silane crosslinking of the POE, intermolecular silane crosslinking of the PVB and POE, or both.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “wt %,” as described herein, refers to the weight fraction of the individual reactants of the formulation used to produce the crosslinked reaction product that comprises the article, unless otherwise noted. For simplicity purposes, “wt %” will be referred to throughout as the amount in the article.

The term “hardness,” as described herein, refers to the Shore A hardness or the Shore D hardness, as indicated, of a material as measured according to ASTM D2240.

The term “sufficient hardness,” as described herein, refers to a hardness from 40 Shore A to 50 Shore D.

The term “compression set,” as described herein, refers to the ability of a material to return to its original thickness after prolonged compressive stress as measured according to ASTM D395 at the temperature and time period indicated.

The term “tensile strength,” as described herein, refers to the maximum stress that a material can withstand while stretching before breaking as measured according to ASTM D638 at 23° C. and a rate of strain of 8.5 mm/s.

The term “tensile elongation,” as described herein, refers to the ratio between increased length and initial length after breakage as measured according to ASTM D638 at 23° C. and a rate of strain of 8.5 mm/s.

The term “100% modulus,” as described herein, refers to the force at 100% tensile elongation as measured according to ASTM D412 at 23° C. and a rate of strain of 8.5 mm/s

The term “specific gravity,” as described herein, refers to the ratio of the density of a material to the density of water as measured according to ASTM D792.

The term “density,” as described herein, refers to the mass per unit volume of a material as measured according to ASTM D792 at 23° C.

The term “dynamic viscosity,” as described herein, refers to the resistance to movement of one layer of a fluid over another as measured according to Hoeppler, DIN 53015 at 20° C.

The term “glass transition temperature,” as described herein, refers to the temperature where a polymer changes from a rigid glassy material to a soft (not melted) material as determined via differential scanning calorimetry in accordance with ISO 11357-1 (2009).

The term “melt flow rate,” as described herein, refers to the ability of a material's melt to flow under pressure as measured according to ASTM D1238 at the given temperature and given weight.

The term “Mooney viscosity,” as described herein, refers to the viscosity reached after a rotor rotates for a given time interval at the specified temperature as measured according to ASTM D1646.

The term “silane grafted,” as described herein, refers to the POE having a silane side chain connected to the polymer main chain. The grafted silane allow intramolecular silane crosslinking of the POE, intermolecular silane crosslinking of the PVB and POE, or both.

The term “intramolecular silane crosslinking,” as described herein, refers to silane crosslinking that occurs when the POE crosslinks with itself.

The term “intermolecular silane crosslinking,” as described herein, refers to silane crosslinking that occurs when the POE crosslinks with the PVB.

The term “copolymer,” as described herein, refers to a polymer formed when two or more monomers are linked in the same chain.

The term “block,” as described herein, refers to a portion of a macromolecule, comprising many constitutional units, that has at least one feature which is not present in the adjacent portions.

The term “olefin block copolymer (OBC),” as described herein, refers to a polymer comprising a plurality of blocks or segments, each comprising an ethylene or propylene repeating unit and an alpha-olefin repeating unit in different mole fractions.

The term “polyolefin,” as described herein, refers to a high crystalline (i.e., greater than or equal to 40% crystalline) blend including a thermoplastic domain, an amorphous elastomer or rubber domain, and optionally a filler.

The term “polyolefin elastomer (POE),” as described herein, refers to a low crystalline (i.e., less than or equal to 25% crystalline) blend including a thermoplastic domain, an amorphous elastomer or rubber domain, and optionally a filler.

The term “ethylene alpha-olefin copolymer,” as described herein, refers to an ethylene alpha-olefin copolymer comprising C₃-C₁₂ olefins.

The terms “virgin PVB,” “virgin ethylene alpha-olefin copolymer,” and “virgin polyolefin,” as described herein, refer to PVB, ethylene alpha-olefin copolymer, or polyolefin, respectively, coming from a source other than a recycled source.

The terms “recycled PVB,” “recycled ethylene alpha-olefin copolymer,” and “recycled polyolefin,” as described herein, refer to PVB, ethylene alpha-olefin copolymer, or polyolefin, respectively, coming from a recycled source.

The terms “bio-based PVB,” “bio-based ethylene alpha-olefin copolymer,” and “bio-based polyolefin,” as described herein, refer to PVB, ethylene alpha-olefin copolymer, or polyolefin, respectively, composed of wholly or significantly recently fixed (new) carbon from biological sources such as renewable plant, forestry, animal, algal, or marine materials (based on C14 content measurement as defined by ASTM D6866).

The term “pure PVB,” as described herein, refers to PVB present in recycled PVB.

As discussed hereinabove, PVB has a desired hardness and binding capabilities, which allows for its use in a wide range of applications, such as coatings and adhesives in automotive and construction applications. However, the PVB may start to degrade at higher temperatures (e.g., greater than or equal to 70° C.), even when crosslinked, and may not be suitable for certain high temperature applications.

Disclosed herein are articles, which mitigate the aforementioned problems. Specifically, the articles disclosed herein include the crosslinked reaction product of PVB, POE, and silane crosslinker, which results in an article having improved compression set at higher temperatures (e.g., greater than or equal to 70° C.) as compared to a conventional PVB article and sufficient hardness (e.g., from 40 Shore A to 50 Shore D). The POE is silane grafted and co-crosslinks with the PVB due to the mixing thereof, leading to an article having improved compression set. Additionally, recycled PVB may be used to increase the recycled content of the article without compromising the compression set as compared to an article including crosslinked POE.

The articles disclosed herein may generally be described as the crosslinked reaction product of PVB, POE, and silane crosslinker.

### Polyvinyl Butyral (PVB)

As described hereinabove, the article comprises PVB, which imparts a desired hardness. The PVB may comprise virgin PVB, recycled PVB, bio-based PVB, or a combination thereof.

In embodiments, the PVB may comprise virgin PVB. In embodiments, the PVB may comprise recycled PVB. In embodiments, the PVB may comprise both virgin PVB and recycled PVB. In embodiments, the PVB may comprise bio-based PVB.

In embodiments, the virgin PVB may have a polyvinyl alcohol content less than or equal to 40 wt %, less than or equal to 35 wt %, less than or equal to 30 wt %, less than or equal to 25 wt %, or even less than or equal to 21 wt %. In embodiments, the virgin PVB may have a polyvinyl alcohol content greater than or equal to 5 wt %, greater than or equal to 10 wt %, greater than or equal to 15 wt %, or even greater than or equal to 18 wt %. In embodiments, the virgin PVB may have a polyvinyl alcohol content from 5 wt % to 40 wt %, from 5 wt % to 35 wt %, from 5 wt % to 30 wt %, from 5 wt % to 25 wt %, from 5 wt % to 21 wt %, from 10 wt % to 40 wt %, from 10 wt % to 35 wt %, from 10 wt % to 30 wt %, from 10 wt % to 25 wt %, from 10 wt % to 21 wt %, from 15 wt % to 40 wt %, from 15 wt % to 35 wt %, from 15 wt % to 30 wt %, from 15 wt % to 25 wt %, from 15 wt % to 21 wt %, from 18 wt % to 40 wt %, from 18 wt % to 35 wt %, from 18 wt % to 30 wt %, from 18 wt % to 25 wt %, or even from 18 wt % to 21 wt %, or any and all sub-ranges formed from any of these endpoints.

In embodiments, the virgin PVB may have a polyvinyl acetate content less than or equal to 6 wt %, less than or equal to 5.5 wt %, less than or equal to 5 wt %, less than or equal to 4.5 wt %, or even less than or equal to 4 wt %. In embodiments, the virgin PVB may have a polyvinyl acetate content greater than or equal to 0.1 wt %, greater than or equal to 0.2 wt %, greater than or equal to 0.5 wt %, or even greater than or equal to 1 wt %. In embodiments, the virgin PVB may have a polyvinyl acetate content from 0.1 wt % to 6 wt %, from 0.1 wt % to 5.5 wt %, from 0.1 wt % to 5 wt %, from 0.1 wt % to 4.5 wt %, from 0.1 wt % to 4 wt %, from 0.2 wt % to 6 wt %, from 0.2 wt % to 5.5 wt %, from 0.2 wt % to 5 wt %, from 0.2 wt % to 4.5 wt %, from 0.2 wt % to 4 wt %, from 0.5 wt % to 6 wt %, from 0.5 wt % to 5.5 wt %, from 0.5 wt % to 5 wt %, from 0.5 wt % to 4.5 wt %, from 0.5 wt % to 4 wt %, from 1 wt % to 6 wt %, from 1 wt % to 5.5 wt %, from 1 wt % to 5 wt %, from 1 wt % to 4.5 wt %, or even from 1 wt % to 4 wt %, or any and all sub-ranges formed from any of these endpoints.

In embodiments, the virgin PVB may have a glass transition temperature less than or equal to 85 Celsius (° C.), less than or equal to 80° C., or even less than or equal to 75° C. In embodiments, the virgin PVB may have a glass transition temperature greater than or equal to 55° C., greater than or equal to 60° C., or even greater than or equal to 65° C. In embodiments, the virgin PVB may have a glass transition temperature from 55° C. to 85° C., from 55° C. to 80° C., from 55° C. to 75° C., from 60° C. to 85° C., from 60° C. to 80° C., from 60° C. to 75° C., from 65° C. to 85° C., from 65° C. to 80° C., or even from 65° C. to 75° C., or any and all sub-ranges formed from any of these endpoints.

In embodiments, the virgin PVB may have a dynamic viscosity of 10 wt % solution in ethanol (containing 5 wt % water) less than or equal to 300 millipascal-second (mPa·s), less than or equal to 280 mPa·s, or even less than or equal to 260 mPa·s. In embodiments, the virgin PVB may have a dynamic viscosity of 10 wt % solution in ethanol (containing 5 wt % water) greater than or equal to 120 mPa·s, greater than or equal to 140 mPa·s, or even greater than or equal to 160 mPa·s. In embodiments, the virgin PVB may have a dynamic viscosity of 10 wt % solution in ethanol (containing 5 wt % water) from 120 mPa·s to 300 mPa·s, from 120 mPa·s to 280 mPa·s, from 120 mPa·s to 260 mPa·s, from 140 mPa·s to 300 mPa·s, from 140 mPa·s to 280 mPa·s, from 140 mPa·s to 260 mPa·s, from 160 mPa·s to 300 mPa·s, from 160 mPa·s to 280 mPa·s, or even from 160 mPa·s to 260 mPa·s, or any and all sub-ranges formed from any of these endpoints.

In embodiments, the virgin PVB may have a dynamic viscosity of 5 wt % solution in n-butanol less than or equal to 90 mPa·s, less than or equal to 85 mPa·s, or even less than or equal to 80 mPa·s. In embodiments, the virgin PVB may have a dynamic viscosity of 5 wt % solution in n-butanol greater than or equal to 35 mPa·s, greater than or equal to 40 mPa·s, or even greater than or equal to 45 mPa·s. In embodiments, the virgin PVB may have a dynamic viscosity of 5 wt % solution in n-butanol from 35 mPa·s to 90 mPa·s, from 35 mPa·s to 85 mPa·s, from 35 mPa·s to 80 mPa·s, from 40 mPa·s to 90 mPa·s, from 40 mPa·s to 85 mPa·s, from 40 mPa·s to 80 mPa·s, from 45 mPa·s to 90 mPa·s, from 45 mPa·s to 85 mPa·s, or even from 45 mPa·s to 80 mPa·s, or any and all sub-ranges formed from any of these endpoints.

Suitable commercial embodiments of the virgin PVB are available under the Mowital brand, such as B 60 H, from Kuraray.

As discussed hereinabove, the PVB may comprise the recycled PVB. Using the recycled PVB in the article may provide environmental benefits, as well as reducing costs. However, in embodiments, the recycled PVB may have impurities and color that may result in undesired properties. Accordingly, in embodiments, the recycled PVB may be processed to remove impurities or adjust color prior to being added to the polymer blend.

The recycled PVB may comprise pure PVB and plasticizer. The plasticizer may comprise triethyleneglycol bis(2-ethylhexanoate), dibutyl sebacate, tetraethylene glycol di-n-heptanoate, dihexyl adipate, dioctyl adipate, hexyl adipate, nonyl adipates, hexyl cyclohexyl adipate, phthalates, phthalate esters, or combinations thereof. In embodiments, the recycled PVB may comprise 70 to 100 wt % of the pure PVB and 0 to 30 wt % of the plasticizer. In embodiments, the recycled PVB may include additives.

In embodiments, the amount of the pure PVB in the recycled PVB may be less than or equal to 100 wt %, less than or equal to 95 wt %, or even less than or equal to 90 wt. In embodiments, the amount of the pure PVB in the recycled PVB may be greater than or equal to 70 wt %, greater than or equal to 75 wt %, or even greater than or equal to 80 wt %. In embodiments, the amount of the pure PVB in the recycled PVB may be from 70 wt % to 100 wt %, from 70 wt % to 95 wt %, from 70 wt % to 90 wt %, from 75 wt % to 100 wt %, from 75 wt % to 95 wt %, from 75 wt % to 90 wt %, from 80 wt % to 100 wt %, from 80 wt % to 95 wt %, or even from 80 wt % to 90 wt %, or any and all sub-ranges formed from any of these endpoints.

In embodiments, the amount of plasticizer in the recycled PVB may be less than or equal to 30 wt %, less than or equal to 25 wt %, or even less than or equal to 20 wt %. In embodiments, the amount of plasticizer in the recycled PVB may be greater than or equal to 0 wt %, greater than or equal to 5 wt %, or even greater than or equal to 10 wt %. In embodiments, the amount of plasticizer in the recycled PVB from 0 wt % to 30 wt %, from 0 wt % to 25 wt %, from 0 wt % to 20 wt %, from 5 wt % to 30 wt %, from 5 wt % to 25 wt %, from 5 wt % to 20 wt %, from 10 wt % to 30 wt %, from 10 wt % to 25 wt %, or even from 10 wt % to 20 wt %, or any and all sub-ranges formed from any of these endpoints.

In embodiments, the recycled PVB may have a Shore A hardness less than or equal to 90, less than or equal to 85, less than or equal to 80, less than or equal to 75, or even less than or equal to 70. In embodiments, the recycled PVB may have a Shore A hardness greater than or equal to 45, greater than or equal to 50, greater than or equal to 55, greater than or equal to 60, or even greater than or equal to 65. In embodiments, the recycled PVB may have a Shore A hardness from 45 to 90, from 45 to 85, from 45 to 80, from 45 to 75, from 45 to 70, from 50 to 90, from 50 to 85, from 50 to 80, from 50 to 75, from 50 to 70, from 55 to 90, from 55 to 85, from 55 to 80, from 55 to 75, from 55 to 70, from 60 to 90, from 60 to 85, from 60 to 80, from 60 to 75, from 60 to 70, from 65 to 90, from 65 to 85, from 65 to 80, from 65 to 75, or even from 65 to 70, or any and all sub-ranges formed from any of these endpoints.

In embodiments, the recycled PVB may have a tensile strength greater than or equal to 0.345 megapascal (MPa) (50 pounds per square inch (psi)), greater than or equal to 6.895 MPa (1000 psi), or even greater than or equal to 13.790 MPa (2000 psi). In embodiments, the recycled PVB may have a tensile strength less than or equal to 34.474 MPa (5000 psi), less than or equal to 27.579 MPa (4000 psi), or even less than or equal to 20.684 MPa (3000 psi). In embodiments, the recycled PVB may have a tensile strength from 0.345 MPa (50 psi) to 34.474 MPa (5000 psi), from 0.345 MPa (50 psi) to 27.579 MPa (4000 psi), from 0.345 MPa (50 psi) to 20.684 MPa (3000 psi), from 6.895 MPa (1000 psi) to 34.474 MPa (5000 psi), from 6.895 MPa (1000 psi) to 27.579 MPa (4000 psi), from 6.895 MPa (1000 psi) to 20.684 MPa (3000 psi), from 13.790 MPa (2000 psi) to 34.474 MPa (5000 psi), from 13.790 MPa (2000 psi) to 27.579 MPa (4000 psi), or even from 13.790 MPa (2000 psi) to 20.684 MPa (3000 psi), or any and all sub-ranges formed from any of these endpoints.

In embodiments, the recycled PVB may have a tensile elongation greater than or equal to 10%, greater than or equal to 50%, or even greater than or equal to 100%. In embodiments, the recycled PVB may have a tensile elongation less than or equal to 500%, less than or equal to 300%, or even less than or equal to 200%. In embodiments, the recycled PVB may have a tensile elongation from 10% to 500%, from 10% to 300%, from 10% to 200%, from 50% to 500%, from 50% to 300%, from 50% to 200%, from 100% to 500%, from 100% to 300%, or even from 100% to 200%, or any and all sub-ranges formed from any of these endpoints.

In embodiments, the recycled PVB may have a specific gravity greater than or equal to 0.8, greater than or equal to 0.9, or even greater than or equal to 1.0. In embodiments, the recycled PVB may have a specific gravity less than or equal to 1.5, less than or equal to 1.3, or even less than or equal to 1.2. In embodiments, the recycled PVB may have a specific gravity from 0.8 to 1.5, from 0.8 to 1.3, from 0.8 to 1.2, from 0.9 to 1.5, from 0.9 to 1.3, from 0.9 to 1.2, from 1.0 to 1.5, from 1.0 to 1.3, or even from 1.0 to 1.2, or any and all sub-ranges formed from any of these endpoints.

Suitable commercial embodiments of the recycled PVB are available under the Shark Pellets brand, such as C2c, C4c, from Shark Solutions.

In embodiments, the amount of PVB in the article may be less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, or even less than or equal to 25 wt %. In embodiments, the amount of PVB in the article may be greater than or equal to 5 wt %, greater than or equal to 7 wt %, greater than or equal to 10 wt %, greater than or equal to 12 wt %, greater than or equal to 14 wt %, greater than or equal to 16 wt %, or even greater than or equal to 18 wt %. In embodiments, the amount of PVB in the article may be from 5 wt % to 60 wt %, from 5 wt % to 55 wt %, from 5 wt % to 50 wt %, from 5 wt % to 45 wt %, from 5 wt % to 40 wt %, from 5 wt % to 35 wt %, from 5 wt % to 30 wt %, from 5 wt % to 25 wt %, from 7 wt % to 60 wt %, from 7 wt % to 55 wt %, from 7 wt % to 50 wt %, from 7 wt % to 45 wt %, from 7 wt % to 40 wt %, from 7 wt % to 35 wt %, from 7 wt % to 30 wt %, from 7 wt % to 25 wt %, from 10 wt % to 60 wt %, from 10 wt % to 55 wt %, from 10 wt % to 50 wt %, from 10 wt % to 45 wt %, from 10 wt % to 40 wt %, from 10 wt % to 35 wt %, from 10 wt % to 30 wt %, from 10 wt % to 25 wt %, from 12 wt % to 60 wt %, from 12 wt % to 55 wt %, from 12 wt % to 50 wt %, from 12 wt % to 45 wt %, from 12 wt % to 40 wt %, from 12 wt % to 35 wt %, from 12 wt % to 30 wt %, from 12 wt % to 25 wt %, from 14 wt % to 60 wt %, from 14 wt % to 55 wt %, from 14 wt % to 50 wt %, from 14 wt % to 45 wt %, from 14 wt % to 40 wt %, from 14 wt % to 35 wt %, from 14 wt % to 30 wt %, from 14 wt % to 25 wt %, from 16 wt % to 60 wt %, from 16 wt % to 55 wt %, from 16 wt % to 50 wt %, from 16 wt % to 45 wt %, from 16 wt % to 40 wt %, from 16 wt % to 35 wt %, from 16 wt % to 30 wt %, from 16 wt % to 25 wt %, from 18 wt % to 60 wt %, from 18 wt % to 55 wt %, from 18 wt % to 50 wt %, from 18 wt % to 45 wt %, from 18 wt % to 40 wt %, from 18 wt % to 35 wt %, from 18 wt % to 30 wt %, or even from 18 wt % to 25 wt %, or any and all sub-ranges formed from any of these endpoints.

In embodiments, the amount of virgin PVB in the article may be less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, or even less than or equal to 25 wt %. In embodiments, the amount of virgin PVB in the article may be greater than or equal to 5 wt %, greater than or equal to 7 wt %, greater than or equal to 10 wt %, greater than or equal to 12 wt %, greater than or equal to 14 wt %, greater than or equal to 16 wt %, or even greater than or equal to 18 wt %. In embodiments, the amount of virgin PVB in the article may be from 5 wt % to 60 wt %, from 5 wt % to 55 wt %, from 5 wt % to 50 wt %, from 5 wt % to 45 wt %, from 5 wt % to 40 wt %, from 5 wt % to 35 wt %, from 5 wt % to 30 wt %, from 5 wt % to 25 wt %, from 7 wt % to 60 wt %, from 7 wt % to 55 wt %, from 7 wt % to 50 wt %, from 7 wt % to 45 wt %, from 7 wt % to 40 wt %, from 7 wt % to 35 wt %, from 7 wt % to 30 wt %, from 7 wt % to 25 wt %, from 10 wt % to 60 wt %, from 10 wt % to 55 wt %, from 10 wt % to 50 wt %, from 10 wt % to 45 wt %, from 10 wt % to 40 wt %, from 10 wt % to 35 wt %, from 10 wt % to 30 wt %, from 10 wt % to 25 wt %, from 12 wt % to 60 wt %, from 12 wt % to 55 wt %, from 12 wt % to 50 wt %, from 12 wt % to 45 wt %, from 12 wt % to 40 wt %, from 12 wt % to 35 wt %, from 12 wt % to 30 wt %, from 12 wt % to 25 wt %, from 14 wt % to 60 wt %, from 14 wt % to 55 wt %, from 14 wt % to 50 wt %, from 14 wt % to 45 wt %, from 14 wt % to 40 wt %, from 14 wt % to 35 wt %, from 14 wt % to 30 wt %, from 14 wt % to 25 wt %, from 16 wt % to 60 wt %, from 16 wt % to 55 wt %, from 16 wt % to 50 wt %, from 16 wt % to 45 wt %, from 16 wt % to 40 wt %, from 16 wt % to 35 wt %, from 16 wt % to 30 wt %, from 16 wt % to 25 wt %, from 18 wt % to 60 wt %, from 18 wt % to 55 wt %, from 18 wt % to 50 wt %, from 18 wt % to 45 wt %, from 18 wt % to 40 wt %, from 18 wt % to 35 wt %, from 18 wt % to 30 wt %, or even from 18 wt % to 25 wt %, or any and all sub-ranges formed from any of these endpoints.

In embodiments, the amount of recycled PVB in the article may be less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, or even less than or equal to 25 wt %. In embodiments, the amount of recycled PVB in the article may be greater than or equal to 5 wt %, greater than or equal to 7 wt %, greater than or equal to 10 wt %, greater than or equal to 12 wt %, greater than or equal to 14 wt %, greater than or equal to 16 wt %, or even greater than or equal to 18 wt %. In embodiments, the amount of recycled PVB in the article may be from 5 wt % to 60 wt %, from 5 wt % to 55 wt %, from 5 wt % to 50 wt %, from 5 wt % to 45 wt %, from 5 wt % to 40 wt %, from 5 wt % to 35 wt %, from 5 wt % to 30 wt %, from 5 wt % to 25 wt %, from 7 wt % to 60 wt %, from 7 wt % to 55 wt %, from 7 wt % to 50 wt %, from 7 wt % to 45 wt %, from 7 wt % to 40 wt %, from 7 wt % to 35 wt %, from 7 wt % to 30 wt %, from 7 wt % to 25 wt %, from 10 wt % to 60 wt %, from 10 wt % to 55 wt %, from 10 wt % to 50 wt %, from 10 wt % to 45 wt %, from 10 wt % to 40 wt %, from 10 wt % to 35 wt %, from 10 wt % to 30 wt %, from 10 wt % to 25 wt %, from 12 wt % to 60 wt %, from 12 wt % to 55 wt %, from 12 wt % to 50 wt %, from 12 wt % to 45 wt %, from 12 wt % to 40 wt %, from 12 wt % to 35 wt %, from 12 wt % to 30 wt %, from 12 wt % to 25 wt %, from 14 wt % to 60 wt %, from 14 wt % to 55 wt %, from 14 wt % to 50 wt %, from 14 wt % to 45 wt %, from 14 wt % to 40 wt %, from 14 wt % to 35 wt %, from 14 wt % to 30 wt %, from 14 wt % to 25 wt %, from 16 wt % to 60 wt %, from 16 wt % to 55 wt %, from 16 wt % to 50 wt %, from 16 wt % to 45 wt %, from 16 wt % to 40 wt %, from 16 wt % to 35 wt %, from 16 wt % to 30 wt %, from 16 wt % to 25 wt %, from 18 wt % to 60 wt %, from 18 wt % to 55 wt %, from 18 wt % to 50 wt %, from 18 wt % to 45 wt %, from 18 wt % to 40 wt %, from 18 wt % to 35 wt %, from 18 wt % to 30 wt %, or even from 18 wt % to 25 wt %, or any and all sub-ranges formed from any of these endpoints.

In embodiments, the amount of bio-based PVB in the article may be less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, or even less than or equal to 25 wt %. In embodiments, the amount of bio-based PVB in the article may be greater than or equal to 5 wt %, greater than or equal to 7 wt %, greater than or equal to 10 wt %, greater than or equal to 12 wt %, greater than or equal to 14 wt %, greater than or equal to 16 wt %, or even greater than or equal to 18 wt %. In embodiments, the amount of bio-based PVB in the article may be from 5 wt % to 60 wt %, from 5 wt % to 55 wt %, from 5 wt % to 50 wt %, from 5 wt % to 45 wt %, from 5 wt % to 40 wt %, from 5 wt % to 35 wt %, from 5 wt % to 30 wt %, from 5 wt % to 25 wt %, from 7 wt % to 60 wt %, from 7 wt % to 55 wt %, from 7 wt % to 50 wt %, from 7 wt % to 45 wt %, from 7 wt % to 40 wt %, from 7 wt % to 35 wt %, from 7 wt % to 30 wt %, from 7 wt % to 25 wt %, from 10 wt % to 60 wt %, from 10 wt % to 55 wt %, from 10 wt % to 50 wt %, from 10 wt % to 45 wt %, from 10 wt % to 40 wt %, from 10 wt % to 35 wt %, from 10 wt % to 30 wt %, from 10 wt % to 25 wt %, from 12 wt % to 60 wt %, from 12 wt % to 55 wt %, from 12 wt % to 50 wt %, from 12 wt % to 45 wt %, from 12 wt % to 40 wt %, from 12 wt % to 35 wt %, from 12 wt % to 30 wt %, from 12 wt % to 25 wt %, from 14 wt % to 60 wt %, from 14 wt % to 55 wt %, from 14 wt % to 50 wt %, from 14 wt % to 45 wt %, from 14 wt % to 40 wt %, from 14 wt % to 35 wt %, from 14 wt % to 30 wt %, from 14 wt % to 25 wt %, from 16 wt % to 60 wt %, from 16 wt % to 55 wt %, from 16 wt % to 50 wt %, from 16 wt % to 45 wt %, from 16 wt % to 40 wt %, from 16 wt % to 35 wt %, from 16 wt % to 30 wt %, from 16 wt % to 25 wt %, from 18 wt % to 60 wt %, from 18 wt % to 55 wt %, from 18 wt % to 50 wt %, from 18 wt % to 45 wt %, from 18 wt % to 40 wt %, from 18 wt % to 35 wt %, from 18 wt % to 30 wt %, or even from 18 wt % to 25 wt %, or any and all sub-ranges formed from any of these endpoints.

### Polyolefin Elastomer (POE)

As described hereinabove, the article includes POE, which is silane grafted and co-crosslinks with the PVB due to the mixing thereof, leading to an article having improved compression set at higher temperatures.

In embodiments, the amount of POE in the article may be less than or equal to 85 wt %, less than or equal to 75 wt %, or even less than or equal to 65 wt %. In embodiments, the amount of POE in the article may be greater than or equal to 10 wt %, greater than or equal to 25 wt %, greater than or equal to 35 wt %, or even greater than or equal to 45 wt %. In embodiments, the amount of POE in the article may be from 10 wt % to 85 wt %, from 10 wt % to 75 wt %, from 10 wt % to 65 wt %, from 25 wt % to 85 wt %, from 25 wt % to 75 wt %, from 25 wt % to 65 wt %, from 35 wt % to 85 wt %, from 35 wt % to 75 wt %, from 35 wt % to 65 wt %, from 45 wt % to 85 wt %, from 45 wt % to 75 wt %, or even from 45 wt % to 65 wt %, or any and all sub-ranges formed from any of these endpoints.

In embodiments, the POE may comprise olefin block copolymer (OBC), ethylene alpha-olefin copolymer, or a combination thereof. In embodiments, the POE may comprise OBC. In embodiments, the POE may comprise ethylene alpha-olefin copolymer. In embodiments, the POE may comprise OBC and ethylene alpha-olefin copolymer.

Various OBC are considered suitable for the present articles. In embodiments, the OBC may comprise an ethylene alpha-olefin repeating unit. The ethylene alpha-olefin repeating unit is the polymerized reaction product of ethylene and C₃-C₁₂ olefins. For example, in embodiments, the ethylene alpha-olefin repeating unit may comprise ethylene-octene copolymer, ethylene-hexene copolymer, ethylene-butene copolymer, or a combination thereof.

In embodiments, the OBC may have a melt flow rate (190° C./2.16 kg) greater than or equal to 1 g/10 min or even greater than or equal to 5 g/10 min. In embodiments, the OBC may have a melt flow rate (190° C./2.16 kg) less than or equal to 25 g/10 min or even less than or equal to 20 g/10 min. In embodiments, the OBC may have a melt flow rate (190° C./2.16 kg) from 1 g/10 min to 25 g/10 min, from 1 g/10 min to 20 g/10 min, from 5 g/10 min to 25 g/10 min, or even from 5 g/10 min to 20 g/10 min, or any and all sub-ranges formed from any of these endpoints.

In embodiments, the OBC may have a density greater than or equal to 0.80 g/cm³ or even greater than or equal to 0.85 g/cm³. In embodiments, the OBC may have a density less than or equal to 0.95 g/cm³ or even less than or equal to 0.90 g/cm³. In embodiments, the OBC may have a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

In embodiments, the OBC may have a tensile strength greater than or equal to 1 MPa or even greater than or equal to 5 MPa. In embodiments, the OBC may have a tensile strength less than or equal to 15 MPa or even less than or equal to 10 MPa. In embodiments, the OBC may have a tensile strength from 1 MPa to 15 MPa, from 1 MPa to 10 MPa, from 5 MPa to 15 MPa, or even from 5 MPa to 10 MPa, or any and all sub-ranges formed from any of these endpoints.

In embodiments, the OBC may have a tensile elongation greater than or equal to 1250% or even greater than or equal to 1500%. In embodiments, the OBC may comprise a tensile elongation less than or equal to 2000% or even less than or equal to 1750%. In embodiments, the OBC may have a tensile elongation from 1250% to 2000%, from 1250% to 1750%, from 1500% to 2000%, or even from 1500% to 1750%, or any and all sub-ranges formed from any of these endpoints.

In embodiments, the OBC may have a Shore A hardness greater than or equal to 50 or even greater than or equal to 60. In embodiments, the OBC may have a Shore A hardness less than or equal to 85 MPa or even less than or equal to 75 MPa. In embodiments, the OBC may have a Shore A hardness from 50 to 85, from 50 to 75, from 60 to 85, or even from 60 to 75, or any and all sub-ranges formed from any of these endpoints.

In embodiments, the OBC may have a compression set less than or equal to 70%, less than or equal to 65%, or even less than or equal to 60% as measured at 70° C.

In embodiments, the amount of OBC in the article may be less than or equal to 85 wt %, less than or equal to 70 wt %, less than or equal to 55 wt %, or even less than or equal to 40 wt %. In embodiments, the amount of OBC in the article may be greater than or equal to 10 wt %, greater than or equal to 15 wt %, greater than or equal to 20 wt %, or even greater than or equal to 25 wt %. In embodiments, the amount of OBC in the article may be from 10 wt % to 85 wt %, from 10 wt % to 70 wt %, from 10 wt % to 55 wt %, from 10 wt % to 40 wt %, from 15 wt % to 85 wt %, from 15 wt % to 70 wt %, from 15 wt % to 55 wt %, from 15 wt % to 40 wt %, from 20 wt % to 85 wt %, from 20 wt % to 70 wt %, from 20 wt % to 55 wt %, from 20 wt % to 40 wt %, from 25 wt % to 85 wt %, from 25 wt % to 70 wt %, from 25 wt % to 55 wt %, or even from 25 wt % to 40 wt %, or any and all sub-ranges formed from any of these endpoints.

Suitable commercial embodiments of OBC are available under the Infuse brand, such as 9500 and 9817, from Dow Chemical Company.

In embodiments, the ethylene-alpha olefin copolymer may comprise virgin ethylene-alpha olefin copolymer, recycled ethylene-alpha olefin copolymer, bio-based ethylene-alpha olefin copolymer, or a combination thereof.

The ethylene alpha-olefin copolymer is the polymerized reaction product of ethylene and C₃-C₁₂ olefins. For example, in embodiments, the ethylene alpha-olefin copolymer may comprise ethylene-octene copolymer, ethylene-hexene copolymer, ethylene-butene copolymer, or a combination thereof.

In embodiments, the ethylene-alpha olefin copolymer may have a melt flow rate (190° C./2.16 kg) greater than or equal to 0.1 g/10 min or even greater than or equal to 0.25 g/10 min. In embodiments, the ethylene-alpha olefin copolymer may have a melt flow rate (190° C./2.16 kg) less than or equal to 3 g/10 min or even less than or equal to 1 g/10 min. In embodiments, the ethylene-alpha olefin copolymer may have a melt flow rate (190° C./2.16 kg) from 0.1 g/10 min to 3 g/10 min, from 0.1 g/10 min to 1 g/10 min, from 0.25 g/10 min to 3 g/10 min, or even from 0.25 g/10 min to 1 g/10 min, or any and all sub-ranges formed from any of these endpoints.

In embodiments, the ethylene-alpha olefin copolymer may have a density greater than or equal to 0.80 g/cm³ or even greater than or equal to 0.85 g/cm³. In embodiments, the ethylene-alpha olefin copolymer may have a density less than or equal to 0.95 g/cm³ or even less than or equal to 0.90 g/cm³. In embodiments, the ethylene-alpha olefin copolymer may have a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

In embodiments, the ethylene-alpha olefin copolymer may have a Mooney viscosity (ML 1+4, 121° C.) greater than or equal to 20, greater than or equal to 30, or even greater than or equal to 40. In embodiments, the ethylene-alpha olefin copolymer may have a Mooney viscosity (ML 1+4, 121° C.) less than or equal to 70, less than or equal to 60, or even less than or equal to 50. In embodiments, the ethylene-alpha olefin copolymer may have a Mooney viscosity (ML 1+4, 121° C.) from 20 to 70, from 20 to 60, from 20 to 50, from 30 to 70, from 30 to 60, from 30 to 50, from 40 to 70, from 40 to 60, or even from 40 to 50, or any and all sub-ranges formed from any of these endpoints.

In embodiments, the ethylene-alpha olefin copolymer may have a tensile strength greater than or equal to 1 MPa or even greater than or equal to 2 MPa. In embodiments, the ethylene-alpha olefin copolymer may have a tensile strength less than or equal to 10 MPa or even less than or equal to 5 MPa. In embodiments, the ethylene-alpha olefin copolymer may have a tensile strength from 1 MPa to 10 MPa, from 1 MPa to 5 MPa, from 2 MPa to 10 MPa, or even from 2 MPa to 5 MPa, or any and all sub-ranges formed from any of these endpoints.

In embodiments, the ethylene-alpha olefin copolymer may have a tensile elongation greater than or equal to 750% or even greater than or equal to 1000%. In embodiments, the ethylene-alpha olefin copolymer may comprise a tensile elongation less than or equal to 1750% or even less than or equal to 1500%. In embodiments, the ethylene-alpha olefin copolymer may have a tensile elongation from 750% to 1750%, from 750% to 1500%, from 1000% to 1750%, or even from 1000% to 1500%, or any and all sub-ranges formed from any of these endpoints.

In embodiments, the ethylene-alpha olefin copolymer may have a Shore A hardness greater than or equal to 40 or even greater than or equal to 45. In embodiments, the ethylene-alpha olefin copolymer may have a Shore A hardness less than or equal to 60 MPa or even less than or equal to 65 MPa. In embodiments, the ethylene-alpha olefin copolymer may have a Shore A hardness from 40 to 60, from 40 to 55, from 45 to 60, or even from 45 to 55, or any and all sub-ranges formed from any of these endpoints.

In embodiments, the amount of ethylene-alpha olefin copolymer in the article may be less than or equal to 50 wt %, less than or equal to 47 wt %, or even less than or equal to 45 wt %. In embodiments, the amount of ethylene-alpha olefin copolymer in the article may be greater than or equal to 30 wt %, greater than or equal to 33 wt %, or even greater than or equal to 35 wt %. In embodiments, the amount of ethylene-alpha olefin copolymer in the article may be from 30 wt % to 50 wt %, from 30 wt % to 47 wt %, from 30 wt % to 45 wt %, from 33 wt % to 50 wt %, from 33 wt % to 47 wt %, from 33 wt % to 45 wt %, from 35 wt % to 50 wt %, from 35 wt % to 47 wt %, or even from 35 wt % to 45 wt %, or any and all sub-ranges formed from any of these endpoints.

Suitable commercial embodiments of the ethylene-alpha olefin copolymer are available under the Engage brand, such as XLT 8677, from Dow Chemical Company.

### Silane Crosslinker

As stated hereinabove, the POE is silane grafted and co-crosslinks with the PVB due to the mixing thereof, leading to an article having improved compression set at higher temperatures.

Various silane crosslinkers are considered suitable for the present articles. In embodiments, the silane crosslinker may comprise vinyl trialkoxysilane. For example, in embodiments, the silane crosslinker may comprise vinyl trimethoxysilane, vinyl triethoxysilane, p-styryl trimethoxy silane, methylvinyldimethoxysilane, vinyldimethyl methoxysilane, divinyldimethoxysilane, vinyltris (2 methoxyethoxy) silane, vinylbenzylethylenediaminopropyltrimethoxysilane, or a combination thereof.

In embodiments, the silane crosslinker may have a specific gravity greater than, equal to 0.9 or even greater than, or equal to 0.95. In embodiments, the silane crosslinker may have a specific gravity less than or equal to 1.05 or even less than or equal to 1. In embodiments, the silane crosslinker may have a specific gravity from 0.9 to 1.05, from 0.9 to 1, from 0.95 to 1.05, or even from 0.95 to 1, or any and all sub-ranges formed from any of these endpoints.

In embodiments, the silane crosslinker may have a melting point greater than or equal to 75° C. or even greater than or equal to 100° C. In embodiments, the silane crosslinker may have a melting point less than or equal to 150° C. or even less than or equal to 125° C. In embodiments, the silane crosslinker may have a melting point from 75° C. to 150° C., from 75° C. to 125° C., from 100° C. to 150° C., or even from 100° C. to 125° C., or any and all sub-ranges formed from any of these endpoints.

In embodiments, the silane crosslinker is included in an amount greater than or equal to 0.5 wt % such that the POE is silane grafted and co-crosslinks with the PVB to produce an article having improved compression set. In embodiments, the amount of silane crosslinker in the article may be less than or equal to 4 wt %, less than or equal to 3.5 wt %, less than or equal to 3 wt %, or even less than or equal to 2.5 wt %. In embodiments, the amount of silane crosslinker in the article may be greater than or equal to 0.1 wt %, greater than or equal to 0.5 wt %, or even greater than or equal to 1 wt %. In embodiments, the amount of silane crosslinker in the article may be from 0.1 wt % to 4 wt %, from 0.1 wt % to 3.5 wt %, from 0.1 wt % to 3 wt %, from 0.1 wt % to 2.5 wt %, from 0.5 wt % to 4 wt %, from 0.5 wt % to 3.5 wt %, from 0.5 wt % to 3 wt %, from 0.5 wt % to 2.5 wt %, from 1 wt % to 4 wt %, from 1 wt % to 3.5 wt %, from 1 wt % to 3 wt %, or even from 1 wt % to 2.5 wt %, or any and all sub-ranges formed from any of these endpoints.

Suitable commercial embodiments of the silane crosslinker are available under the SILQUEST brand, such as A-171, from Momentive.

In embodiments, the silane crosslinker may be included in a solution comprising organic peroxide such that the silane crosslinker is better dispersed within POE, leading to improved silane grafting.

In embodiments, the organic peroxide may comprise di-t-butyl peroxide; t-butyl cumyl peroxide; dicumyl peroxide; 1,3-bis (t-butyl peroxy-isopropyl)benzene; n-butyl-4,4-bis (t-butyl-peroxy) valerate; benzoyl peroxide; t-butylperoxybenzoate; t-butylperoxy isopropyl carbonate; t-butylperbenzoate; bis(2-methylbenzoyl) peroxide; bis(4-methylbenzoyl) peroxide; t-butyl peroctoate; cumene hydroperoxide; methyl ethyl ketone peroxide; lauryl peroxide; tert-butyl peracetate; di-t-amyl peroxide; t-amyl peroxybenzoate; 1,1-bis (t-butylperoxy)-3,3,5-trimethylcyclohexane; 2,5-bis (t-butylperoxy)-2,5 dimethylhexane; 2,5-bis (t-butylperoxy)-2,5-dimethyl-3-hexyne; 2,4-dichlorobenzoyl peroxide; or a combination thereof

In embodiments, the organic peroxide may have a density greater than or equal to 1.00 g/cm³ or even greater than or equal to 1.05 g/cm³. In embodiments, the organic peroxide may have a density less than or equal to 1.20 g/cm³ or even less than or equal to 1.15 g/cm³. In embodiments, the organic peroxide may have a density from 1.00 g/cm³ to 1.20 g/cm³, from 1.00 g/cm³ to 1.15 g/cm³, from 1.05 g/cm³ to 1.20 g/cm³, or even from 1.05 g/cm³ to 1.15 g/cm³, or any and all sub-ranges formed from any of these endpoints.

In embodiments, the organic peroxide may have a melting point greater than or equal to 75° C. or even greater than or equal to 100° C. In embodiments, the organic peroxide may have a melting point less than or equal to 150° C. or even less than or equal to 125° C. In embodiments, the organic peroxide may have a melting point from 75° C. to 150° C., from 75° C. to 125° C., from 100° C. to 150° C., or even from 100° C. to 125° C., or any and all sub-ranges formed from any of these endpoints.

In embodiments, the amount of organic peroxide in the article may be greater than or equal to 0.05 wt % or even greater than or equal to 0.1 wt %. In embodiments, the amount of organic peroxide in the article may be less than or equal to 1 wt % or even less than or equal to 0.5 wt %. In embodiments, the amount of organic peroxide in the article may be from 0.05 wt % to 1 wt %, from 0.05 wt % to 0.5 wt %, from 0.1 wt % to 1 wt %, or even from 0.1 wt % to 0.5 wt %, or any and all sub-ranges formed from any of these endpoints.

Suitable commercial embodiments of the organic peroxide are available under the PERKADOX brand, such as BC-FF, from AkzoNobel.

### Article

As described herein, the silane crosslinking of PVB with POE produces an article having improved compression set at higher temperatures (e.g., greater than or equal to 70° C.) and sufficient hardness (e.g., from 40 Shore A to 50 Shore D).

In embodiments, the silane crosslinking may be intramolecular silane crosslinking of the POE, intermolecular silane crosslinking of the PVB and POE, or both.

In embodiments, the article may have a compression set less than or equal to 40%, less than or equal to 37%, less than or equal to 35%, less than or equal to 33%, or even less than or equal to 30, as measured at 70° C.

In embodiments, the article may have a compression set less than or equal to 50%, less than or equal to 45%, less than or equal to 40%, less than or equal to 35%, or even less than or equal to 30%, as measured at 150° C.

In embodiments, the article may have a hardness greater than or equal to 40 Shore A, greater than or equal to 50 Shore A, or even greater than or equal to 60 Shore A. In embodiments, the article may have a hardness less than or equal to 50 Shore D, less than or equal to 40 Shore D, or even less than or equal to 80 Shore A. In embodiments, the article may have a hardness from 40 Shore A to 50 Shore D, from 40 Shore A to 40 Shore D, from 40 Shore A to 80 Shore A, from 50 Shore A to 50 Shore D, from 50 Shore A to 40 Shore D, from 50 Shore A to 80 Shore A, from 60 Shore A to 50 Shore D, from 60 Shore A to 40 Shore D, or even from 60 Shore A to 80 Shore A, or any and all sub-ranges formed from any of these endpoints.

In embodiments, the article may have a specific gravity greater than or equal to 0.8 or even greater than or equal to 0.9. In embodiments, the article may have a specific gravity less than or equal to 1.2, less than or equal to 1.1, or even less than or equal to 1.0. In embodiments, the article may have a specific gravity from 0.8 to 1.2, from 0.8 to 1.1, from 0.8 to 1.0, from 0.9 to 1.2, from 0.9 to 1.1, or even from 0.9 to 1.0, or any and all sub-ranges formed from any of these endpoints.

In embodiments, the article may have a 100% modulus greater than or equal to 3.5 MPa, greater than or equal to 4.0 MPa, or even greater than or equal to 4.5 MPa. In embodiments, the article may have a 100% modulus less than or equal to 8.5 MPa, less than or equal to 8.0 MPa, or even less than or equal to 7.5 MPa. In embodiments, the article may have a 100% modulus from 3.5 MPa to 8.5 MPa, from 3.5 MPa to 8.0 MPa, from 3.5 MPa to 7.5 MPa, from 4.0 MPa to 8.5 MPa, from 4.0 MPa to 8.0 MPa, from 4.0 MPa to 7.5 MPa, from 4.5 MPa to 8.5 MPa, from 4.5 MPa to 8.0 MPa, or even from 4.5 MPa to 7.5 MPa, or any and all sub-ranges formed from any of these endpoints.

In embodiments, the article may have a tensile strength greater than or equal to 4.5 MPa, greater than or equal to 5.0 MPa, or even greater than or equal to 5.5 MPa. In embodiments, the article may have a tensile strength less than or equal to 8.5 MPa, less than or equal to 8.0 MPa, less than or equal to 7.5 MPa, or even less than or equal to 7.0 MPa. In embodiments, the article may have a tensile strength from 4.5 MPa to 8.5 MPa, from 4.5 MPa to 8.0 MPa, from 4.5 MPa to 7.5 MPa, from 4.5 MPa to 7.0 MPa, from 5.0 MPa to 8.5 MPa, from 5.0 MPa to 8.0 MPa, from 5.0 MPa to 7.5 MPa, from 5.0 MPa to 7.0 MPa, from 5.5 MPa to 8.5 MPa, from 5.5 MPa to 8.0 MPa, from 5.5 MPa to 7.5 MPa, or even from 5.5 MPa to 7.0 MPa, or any and all sub-ranges formed from any of these endpoints.

In embodiments, the article may have a tensile elongation greater than or equal to 70% or even greater than or equal to 90%. In embodiments, the article may have a tensile elongation less than or equal to 175%, less than or equal to 150% or even less than or equal to 125%. In embodiments, the article may have a tensile elongation from 70% to 175%, from 70% to 150%, from 70% to 125%, from 90% to 175%, from 90% to 150%, or even from 90% to 125%, or any and all sub-ranges formed from any of these endpoints.

As exemplified in the Examples section below, the articles described herein comprising a crosslinked reaction product of PVB, POE, and silane crosslinker have improved compression set at higher temperature and sufficient hardness. Additionally, recycled PVB may be used to increase the recycled content of the article without compromising the compression set.

### Polyolefin

In embodiments, the articles described herein may further comprise polyolefin to assist with processability and adjustment of article properties (e.g., hardness).

In embodiments, the polyolefin may comprise virgin polyolefin, recycled polyolefin, bio-based polyolefin, or a combination thereof.

Various polyolefins are considered suitable for the present articles. In embodiments, the polyolefin may comprise a propylene-based polyolefin, an ethylene-based polyolefin, or a combination thereof.

In embodiments, the polyolefin may comprise polypropylene (PP). In embodiments, the PP may comprise a polypropylene homopolymer (i.e., composed of propylene monomers) or a polypropylene copolymer having greater than 50 wt % propylene monomer and an additional comonomer such as C₂ and C₄-C₁₂ alpha olefins.

In embodiments, the polypropylene may have a melt flow rate (230° C./2.16 kg) greater than or equal to 0.1 g/10 min, greater than or equal to 0.5 g/10 min, greater than or equal to 1 g/10 min, greater than or equal to 5 g/10 min, greater than or equal to 10 g/10 min, or even greater than or equal to 20 g/10 min. In embodiments, the polypropylene may have a melt flow rate (230° C./2.16 kg) less than or equal to 50 g/10 min, less than or equal to 40 g/10 min, less than or equal to 30 g/10 min, less than or equal to 20 g/10 min, or even less than or equal to 10 g/10 min. In embodiments, the polypropylene may have a melt flow rate (230° C./2.16 kg) from 0.1 g/10 min to 50 g/10 min, from 0.1 g/10 min to 40 g/10 min, from 0.1 g/10 min to 30 g/10 min, from 0.1 g/10 min to 20 g/10 min, from 0.1 g/10 min to 10 g/10 min, from 0.5 g/10 min to 50 g/10 min, from 0.5 g/10 min to 40 g/10 min, from 0.5 g/10 min to 30 g/10 min, from 0.5 g/10 min to 20 g/10 min, from 0.5 g/10 min to 10 g/10 min, from 1 g/10 min to 50 g/10 min, from 1 g/10 min to 40 g/10 min, from 1 g/10 min to 30 g/10 min, from 1 g/10 min to 20 g/10 min, from 1 g/10 min to 10 g/10 min, from 5 g/10 min to 50 g/10 min, from 5 g/10 min to 40 g/10 min, from 5 g/10 min to 30 g/10 min, from 5 g/10 min to 20 g/10 min, from 5 g/10 min to 10 g/10 min, from 10 g/10 min to 50 g/10 min, from 10 g/10 min to 40 g/10 min, from 10 g/10 min to 30 g/10 min, from 10 g/10 min to 20 g/10 min, from 20 g/10 min to 50 g/10 min, from 20 g/10 min to 40 g/10 min, or even from 20 g/10 min to 30 g/10 min, or any and all sub-ranges formed from any of these endpoints.

In embodiments, the polyolefin may comprise polyethylene (PE). In embodiments, the PE may comprise a polyethylene homopolymer (i.e., composed of ethylene monomers) or a polyethylene copolymer having greater than 50 wt % ethylene monomer and an additional comonomer, such as C₃-C₁₂ alpha olefins. In embodiments, the PE may comprise high density polyethylene (HDPE), low density polyethylene (LDPE), linear low density polyethylene (LLDPE), or combination thereof.

In embodiments, the polyolefin may comprise a density greater than or equal to 0.8 g/cm³ or even greater than or equal to 0.85 g/cm³. In embodiments, the polyolefin may comprise a density less than or equal to 1.10 g/cm³ or even less than or equal to 1.00 g/cm³. In embodiments, the polyolefin may comprise a density from 0.80 g/cm³ to 1.10 g/cm³, from 0.80 g/cm³ to 1.00 g/cm³, from 0.85 g/cm³ to 1.10 g/cm³, or even from 0.85 g/cm³ to 1.00 g/cm³, or any and all sub-ranges formed from any of these endpoints.

In embodiments, the polyolefin may have a melting point greater than or equal to 100° C., greater than or equal to 110° C., or even greater than or equal to 120° C.

In embodiments, the amount of polyolefin in the article may be less than or equal to 30 wt %, less than or equal to 25 wt %, less than or equal to 20 wt %, less than or equal to 15 wt %, or even less than or equal to 10 wt %. In embodiments, the amount of polyolefin in the article may be greater than or equal to 1 wt %, greater than or equal to 2 wt %, greater than or equal to 2 wt %, or even greater than or equal to 6 wt %. In embodiments, the amount of polyolefin in the article may be from 1 wt % to 30 wt %, from 1 wt % to 25 wt %, from 1 wt % to 20 wt %, from 1 wt % to 15 wt %, from 1 wt % to 10 wt %, from 2 wt % to 30 wt %, from 2 wt % to 25 wt %, from 2 wt % to 20 wt %, from 2 wt % to 15 wt %, from 2 wt % to 10 wt %, from 4 wt % to 30 wt %, from 4 wt % to 25 wt %, from 4 wt % to 20 wt %, from 4 wt % to 15 wt %, from 4 wt % to 10 wt %, from 6 wt % to 30 wt %, from 6 wt % to 25 wt %, from 6 wt % to 20 wt %, from 6 wt % to 15 wt %, or even from 6 wt % to 10 wt %, or any and all sub-ranges formed from any of these endpoints.

Suitable commercial embodiments of the polyolefin are available under the FORMOLENE brand, such as polypropylene homopolymer 1102KR, from Formosa Plastics; and under the PRO-FAX brand, such as polyprolyene homopolymer PD702, from LyondellBasell.

### Moisture Cure Catalyst

In embodiments, the article may comprise a moisture cure catalyst to initiate silane crosslinking of POE and/or PVB and POE.

In embodiments, the moisture cure catalyst may comprise organic basis, carboxylic acids, metallic stearates, organometallic compounds (e.g., organic titanates and complexes or carboxylates of lead, cobalt, iron, nickel, zinc, or tin), or a combination thereof.

In embodiments, the catalyst is blended with the PVB, POE, and silane crosslinker during silane grafting. In embodiments, the catalyst is added to the extruded or molded formulation, wherein the POE is silane grafted. The POE that is silane grafted will crosslink upon exposure to moisture (e.g., air).

### Plasticizer

In embodiments, the articles described herein may further comprise plasticizer to improve flow.

In embodiments, the plasticizer may comprise triethylene glycol bis(2-ethylhexanoate), triethyleneglycol bis(2-ethylhexanoate), dibutyl sebacate, tetraethylene glycol di-n-heptanoate, dihexyl adipate, dioctyl adipate, hexyl adipates (e.g., cyclohexyl adipate), nonyl adipates, phthalates, phthalate esters, or a combination thereof. In embodiments, the plasticizer may comprise mineral oil, synthetic oil, poly-alpha-olefin, polyethylene copolymer, polyisobutene, or a combination thereof.

In embodiments, the amount of plasticizer in the article may be less than or equal to 18 wt %, less than or equal to 16 wt %, or even less than or equal to 14 wt %. In embodiments, the amount of plasticizer in the article may be greater than or equal to 2 wt %, greater than or equal to 4 wt %, or even greater than or equal to 6 wt %. In embodiments, the amount of plasticizer in the article may be from 2 wt % to 18 wt %, from 2 wt % to 16 wt %, from 2 wt % to 14 wt %, from 4 wt % to 18 wt %, from 4 wt % to 16 wt %, from 4 wt % to 14 wt %, from 6 wt % to 18 wt %, from 6 wt % to 16 wt %, or even from 6 wt % to 14 wt %, or any and all sub-ranges formed from any of these endpoints.

### Additives

In embodiments, the article may further comprise an additive. In embodiments, the additive may comprise adhesion promoters; biocides; anti-fogging agents; anti-static agents; blowing and foaming agents; bonding agents and bonding polymers; polar copolymers (e.g., ethylene-vinyl acetate (EVA), ethylene butyl acrylate (EBA), or ethyl methacrylate (EMA)); dispersants; flame retardants and smoke suppressants; mineral fillers; initiators; lubricants; micas; pigments, colorants, and dyes; processing aids; release agents; silanes, titanates, and zirconates; slip and anti-blocking agents; stearates; ultraviolet light stabilizers; antioxidants; viscosity regulators; waxes; or a combination thereof.

In embodiments, the flame retardants may comprise a non-halogenated flame retardant. In embodiments, the non-halogenated flame retardant may comprise organo-phosphinate, melamine polyphosphate, or a combination thereof. Suitable commercial embodiments of the organo-phosphinate are available under the EXOLIT brand, such as OP 930, OP 935, OP 1311, OP 1312, and OP1230, from Clariant Corporation. Suitable commercial embodiments of the melamine polyphosphate are available under the JLS-PNA and JLS-PNB brands from JLS Flame Retardants Chemical Co. (Hangzhou Zhejiang, China) and under the MELASPUR 200 brand from Ciba Specialty Chemicals.

In embodiments, the ultraviolet light stabilizers may comprise benzotriazoles, benzophenones, organic nickel compounds, hindered amine light stabilizers (HALS), or a combination thereof.

In embodiments, the antioxidants may comprise pentaerythritol, trisarylphoshite, or a combination thereof. Suitable commercial embodiments of the pentaerythritol are available under the Irganox brand from BASF. Suitable commercial embodiments of the trisarylphosphite are available under the Irgafos brand from BASF.

### Process

In embodiments, the article described herein may be made with a batch process or continuous process.

In embodiments, the components of the article, including the PVB, the POE, and the silane crosslinker may be added to an extruder (e.g., 27 MM Leistriz Twin Extruder (L/D 52)) and blended. In embodiments, silane crosslinker is added to the blend such that the POE is silane grafted. In embodiments, the blending (e.g., in the barrel of the extruder) may be carried out at a temperature from 150° C. to 220° C.

Blending (also known as compounding) devices are well known to those skilled in the art and generally include feed means, especially at least one hopper for pulverulent materials and/or at least one injection pump for liquid materials; high-shear blending means, for example a co-rotating or counter-rotating twin-screw extruder, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die. For example, in embodiments, the process may comprise profile extrusion including forcing the extrudate through a die cut into the linear shape of the desired finished article (e.g., channel or tube).

In embodiments, the shaped, silane-grafted blend may be cured such that the PVB and the POE are silane crosslinked. In embodiments, the catalyst is blended with the PVB, POE, and the silane crosslinker during silane grafting. In other embodiments, the catalyst is added at the extrusion step.

### EXAMPLES

Table 1 below shows sources of ingredients for the formulations used to form the articles of Comparative Examples C1, C2, and C3 and Examples E1 to E9.

TABLE 1

| Ingredients | Brand | Source |
|---|---|---|
| recycled PVB | SHARK PELLETS C2c | Shark Solutions |
| PVB | MOWITAL B 60H | Kuraray |
| OBC | INFUSE 9500 | Dow Chemical |
| | | Company |
| OBC | INFUSE 9817 | Dow Chemical |
| | | Company |
| ethylene alpha- | ENGAGE XLT 8677 | Dow Chemical |
| olefin copolymer | | Company |
| polypropylene | FORMOLENE 1102KR | Formosa Plastics |
| polypropylene | PRO-FAX PD702 | LyondellBasell |
| recycled polypropylene | SYNCOT PP | Syncot Plastics |
| white mineral oil | PURETOL 550 | Petro-Canada |
| (plasticizer) | | Lubricants |
| triethylene glycol bis (2- | TEG-EH | Eastman Chemical |
| ethylhexanoate) | | |
| (plasticizer) | | |
| vinyltrimethoxy silane | SILQUEST A-171 | Momentive |
| (silane crosslinker) | | |
| dicumyl peroxide | PERKADOX BC-FF | AkzoNobel |
| (initiator) | | |

Table 2 below shows the formulations used to form and the certain properties of Comparative Examples C1, C2 and C3 and Examples E1 to E9.

TABLE 2

| | Example | | | | | | | | | |
|---|---|---|---|---|---|---|---|---|---|---|
| | C1 | | C2 | | C3 | | E1 | | E2 | |
| Ingredient | Parts | Wt % | Parts | Wt % | Parts | Wt % | Parts | Wt % | Parts | Wt % |
| SHARK PELLETS C2c | 100 | 100 | 0 | 0 | 0 | 0 | 20 | 16.3 | 30 | 22.6 |
| INFUSE 9500 | 0 | 0 | 100 | 97.1 | 100 | 100 | 100 | 81.3 | 100 | 75.2 |
| PURETOL 550 | 0 | 0 | 0 | 0 | 0 | 0 | 0 | 0 | 0 | 0 |
| SILQUEST A-171 | 0 | 0 | 2.7 | 2.6 | 0 | 0 | 2.7 | 2.2 | 2.7 | 2 |
| PERKADOX BC-FF | 0 | 0 | 0.3 | 0.3 | 0 | 0 | 0.3 | 0.2 | 0.3 | 0.2 |
| TOTAL | 100 | 100 | 103 | 100 | 100 | 100 | 123 | 100 | 133 | 100 |

| | | | | | |
|---|---|---|---|---|---|
| Hardness (Shore A) | 68 | 78 | 69 | 80 | 75 |
| Specific gravity | 1.13 | 0.88 | 0.87 | 0.9 | 0.91 |
| 100% modulus (MPa) | 11.45 | 4.7 | 1.9 | — | 4.8 |
| Tensile strength (MPa) | 19.44 | 4.87 | 6.16 | 5.81 | 5.01 |
| Tensile elongation (%) | 154 | 111 | 1248 | 93 | 126 |
| Compression set | 94 | 22 | 54 | 25 | 25 |
| (70° C., 22 hrs, %) | | | | | |
| Compression set | 100 | 22 | 100 | 24 | 27 |
| (150° C., 22 hrs, %) | | | | | |

| | Example | |
|---|---|---|
| | E3 | |
| Ingredient | Parts | Wt % |
| SHARK PELLETS C2c | 30.0 | 19.6 |
| INFUSE 9500 | 100.0 | 65.4 |
| PURETOL 550 | 20.0 | 13.1 |
| SILQUEST A-171 | 2.7 | 1.8 |
| PERKADOX BC-FF | 0.3 | 0.2 |
| TOTAL | 153.0 | 100.0 |

| | |
|---|---|
| Hardness (Shore A) | 67 |
| Specific gravity | 0.90 |
| 100% modulus (MPa) | 4.07 |
| Tensile strength (MPa) | 4.15 |
| Tensile elongation (%) | 108 |
| Compression set | 23 |
| (70° C., 22 hrs, %) | |
| Compression set | 25 |
| (150° C., 22 hrs, %) | |

| | Example | | | | | | | |
|---|---|---|---|---|---|---|---|---|
| | E4 | | E5 | | E6 | | E7 | |
| Ingredient | Parts | Wt % | Parts | Wt % | Parts | Wt % | Parts | Wt % |
| SHARK PELLETS C2c | 40.0 | 28.2 | 40.0 | 28.2 | | | 40.0 | 28.2 |
| MOWITAL B 60H | | | | | 30.0 | 21.1 | | |
| INFUSE 9817 | 30.0 | 21.1 | 30.0 | 21.1 | 30.0 | 21.1 | 50.0 | 35.2 |
| ENGAGE XLT 8677 | 60.0 | 42.3 | 60.0 | 42.3 | 60.0 | 42.3 | 50.0 | 35.2 |
| FORMOLENE 1102KR | 10.0 | 7.0 | | | 10.0 | 7.0 | | |
| SYNCOT PP | | | 10.0 | 7.0 | | | | |
| TEG-EH | | | | | 10.0 | 7.0 | | |
| SILQUEST A-171 | 1.8 | 1.3 | 1.8 | 1.3 | 1.8 | 1.3 | 1.8 | 1.3 |
| PERKADOX BC-FF | 0.2 | 0.1 | 0.2 | 0.1 | 0.2 | 0.1 | 0.2 | 0.1 |
| TOTAL | 142.0 | 100.0 | 142.0 | 100.0 | 142.0 | 100.0 | 142.0 | 100.0 |

| | | | | |
|---|---|---|---|---|
| Hardness (Shore A) | 78 | 75 | 78 | 71 |
| Specific gravity | 0.91 | 0.92 | 0.92 | 0.91 |
| 100% modulus (MPa) | 7.77 | 5.47 | — | 5.35 |
| Tensile strength (MPa) | 7.97 | 5.50 | 5.94 | 5.56 |
| Tensile elongation (%) | 122 | 110 | 94 | 118 |
| Compression set | 30 | 33 | 36 | 29 |
| (70° C., 22 hrs, %) | | | | |
| Compression set | 22 | 26 | 25 | 24 |
| (150° C., 22 hrs, %) | | | | |

| | Example | | | |
|---|---|---|---|---|
| | E8 | | E9 | |
| Ingredient | Parts | Wt % | Parts | Wt % |
| SHARK PELLETS C2c | 34.0 | 25.1 | 37.0 | 25.0 |
| INFUSE 9817 | 30.0 | 22.2 | 30.0 | 20.3 |
| ENGAGE XLT 8677 | 50.0 | 37.0 | 60.0 | 40.6 |
| PRO-FAX PD702 | 20.0 | 14.8 | 20.0 | 13.5 |
| SILQUEST A-171 | 1.2 | 0.9 | 0.8 | 0.5 |
| PERKADOX BC-FF | 0.1 | 0.1 | 0.1 | 0.1 |
| TOTAL | 135.3 | 100.0 | 147.9 | 100.0 |

| | | |
|---|---|---|
| Hardness (Shore A) | 84 | 83 |
| Specific gravity | 0.93 | 0.92 |
| 100% modulus (MPa) | 8.10 | 7.30 |
| Tensile strength (MPa) | 8.23 | 7.40 |
| Tensile elongation (%) | 132 | 129 |
| Compression set | 35 | 37 |
| (70° C., 22 hrs, %) | | |
| Compression set | 36 | 37 |
| (150° C., 22 hrs, %) | | |

As shown in Table 2, Examples E1-E9, articles including PVB (SHARK PELLETS C2C or MOWITAL B 60H) with OBC (INFUSE 9500) or OBC (INFUSE 9817) and ethylene alpha-olefin copolymer (ENGAGE XLT 8677), showed a reduced compression set as compared to Comparative Example C1, an article including SHARK PELLETS C2C. As indicated by Comparative Example E1 and Examples E1-E9, co-crosslinking PVB with silane grafted POE results in a temperature resistant article as compared to an article including PVB without POE.

As also shown in Table 2, Examples E1-E3, articles including recycled PVB (SHARK PELLETS C2C) and OBC (INFUSE 9500), showed a similar compression set as compared to Comparative Example C2, an article including crosslinked OBC (INFUSE 9500). As indicated by Comparative Example C2 and Examples E1-E3, the recycled content of an article may be increased by co-crosslinking recycled PVB with silane grafted POE without compromising the compression set of the resulting article as compared to an article including crosslinked POE.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

What is claimed is:

1. An article comprising a crosslinked reaction product of:
polyvinyl butyral (PVB), wherein the PVB comprises virgin PVB, recycled PVB, bio-based PVB, or a combination thereof;
polyolefin elastomer (POE), wherein the polyolefin elastomer comprises olefin block copolymer (OBC), ethylene alpha-olefin copolymer, or a combination thereof; and
silane crosslinker;
wherein the POE is silane grafted, and
wherein the grafted silane enables intramolecular silane crosslinking of the POE, intermolecular silane crosslinking of the PVB and POE, or both.

2. The article of claim 1, wherein the article comprises 5 wt % to 60 wt % of the PVB and 10 wt % to 85 wt % of the POE.

3. (canceled)

4. The article of claim 1, wherein the article comprises 10 wt % to 85 wt % of the OBC.

5. The article of claim 1, wherein the OBC comprises an ethylene alpha-olefin repeating unit.

6. The article of claim 5, wherein the ethylene alpha-olefin repeating unit comprises ethylene-octene copolymer, ethylene-hextene copolymer, ethylene-butene copolymer, or a combination thereof.

7. The article of claim 1, wherein the POE comprises the OBC and the ethylene-alpha olefin copolymer.

8. (canceled)

9. The article of claim 1, wherein the article comprises 30 wt % to 50 wt % of the ethylene-alpha olefin copolymer.

10. The article of claim 1, wherein the ethylene alpha-olefin copolymer comprises ethylene-octene copolymer, ethylene-hextene copolymer, ethylene-butene copolymer, or a combination thereof.

11. The article of claim 1, wherein the article comprises 0.1 wt % to 4 wt % of the silane crosslinker.

12. (canceled)

13. (canceled)

14. The article of claim 1, wherein the silane crosslinker is included in a solution comprising organic peroxide.

15. (canceled)

16. The article of claim 1, wherein the article further comprises polyolefin, the polyolefin comprising virgin polyolefin, recycled polyolefin, bio-based polyolefin, or a combination thereof.

17. (canceled)

18. (canceled)

19. (canceled)

20. (canceled)

21. The article of claim 1, wherein the article further comprises a moisture cure catalyst.

22. (canceled)

23. The article of claim 1, wherein the article further comprises plasticizer.

24. (canceled)

25. (canceled)

26. (canceled)

27. The article of claim 1, wherein the article has a compression set less than or equal to 40% as measured at 70° C.

28. The article of claim 1, wherein the article has a compression set less than or equal to 50% as measured at 150° C.

29. The article of claim 1, wherein the article has a hardness greater than or equal to 40 Shore A and less than or equal to 50 Shore D.

30. The article of claim 1, wherein the article further comprises an additive, the additive comprising adhesion promoters; biocides; anti-fogging agents; anti-static agents; blowing and foaming agents; bonding agents and bonding polymers; polar copolymers; dispersants; flame retardants and smoke suppressants; mineral fillers; initiators; lubricants; micas; pigments, colorants, and dyes; processing aids; release agents; silanes, titanates, and zirconates; slip and anti-blocking agents; stearates; ultraviolet light stabilizers; antioxidants; viscosity regulators; waxes; or a combination thereof.

31. The article of claim 30, wherein the flame retardants comprise a non-halogenated flame retardant.

32. (canceled)

33. (canceled)

34. A process for making an article comprising a crosslinked reaction product of polyvinyl butyral (PVB), polyolefin elastomer (POE), and silane crosslinker, the process comprising the steps of:
blending the PVB and POE;
grafting the blend with silane such that the POE is silane grafted;
shaping the silane-grafted blend; and
curing the shaped, silane-grafted blend such the PVB and POE are silane crosslinked.

35. The process of claim 34, wherein shaping the silane-grafted blend comprises profile extrusion.
